(19) United States
(12) Patent Application Publication
(10) Pub. No.: US 2006/0129405 A1
(43) Pub. Date: Jun. 15, 2006

(54) Method and device for determining a personal happiness index and improving it

(76) Inventor: Shlomo Elfanbaum, Kefar Vitkin (IL)

Correspondence Address: Mark M Friedman;Bill Polkinghorn, 9003 Florin Way, Upper Marlboro, MD, 20772, US

(21) Appl. No.: 10/541,557

(22) PCT Filed: Dec. 21, 2003
(86) PCT No.: PCT/IL03/01093

§ 371 Date: Jul. 6, 2005

(30) Foreign Application Priority Data
Jan. 12, 2003 (IL) 153886

(51) Int. Cl. G10L 21/00

(52) U.S. Cl. 704/270

(57) ABSTRACT

A method and apparatus allowing the user to characterize a system for minoring his personal variables affecting his emotional state, and identifying his personal happiness index for himself. Relating to and updating the variables and receiving feedback on them relative to himself and between himself and others. The apparatus is based on various physiological and emotional components, each of which together and individually affect our emotional state.

### DESCRIPTION OF THE INVENTION

Note: Phrases in the masculine gender will also refer to feminine. Masculine has been used for the sake of convenience.

A method and apparatus allowing the user to characterize a system for monitoring his personal variables affecting his emotional state, and identifying his personal happiness index for himself.

Relating to and updating the variables and receiving feedback on them relative to himself and between himself and others.

The apparatus is based on various physiological and emotional components, each of which together and individually affect our emotional state.

The Method and Apparatus Allowing the User to Reflect and Increase His Happiness.

Inner happiness stems from an inner sense and is not necessarily dependent but on our ability to manage our feelings regarding events and activities that we experience.

Man's happiness is determined by many different personal attributes.

Everyone has a number of major attributes that affect his happiness.

Some of us are aware of these attributes and promote them in order to be happy, while some of us are unaware of them and live our lives attempting to be happy but lacking the tools to improve.

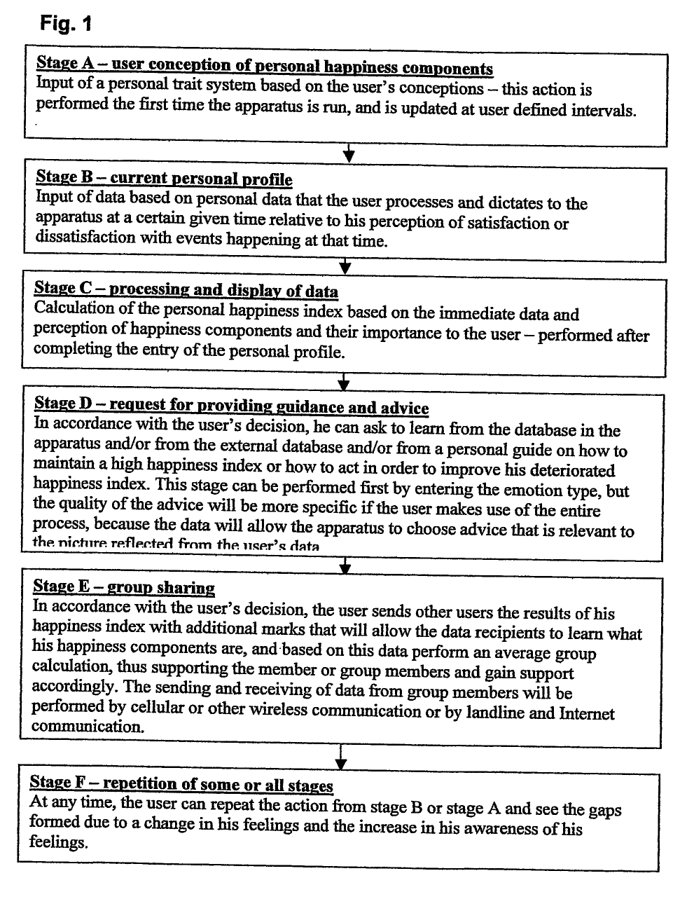

The Invention Submitted Bellow Allows Us (See FIG. 1):

A. To establish our identifiable personal attributes and refresh them from time to time.

B. To establish our general attitude to these components through defining the importance of each of the set of components for us through a quantitative index.

C. To identify our situation for a given moment regarding these attributes on a quantitative scale.

D. To receive our personal happiness scale we reflect for that moment and receive an average happiness index for a given time, as long as we have set and saved the data in the apparatus.

E. To receive dos and don'ts from a professional advice bank from the apparatus or a bank connected to the user that will assist him in his promoting and improving his happiness index in the immediate term and long term.

F. To communicate our personal happiness index and its attributes to others in order support to be supported by others or a group, by Internet, cellular phones or any other means of communication.

Existing Field—Review of Patents in the Field.

A widespread search for patents identical or similar to the submitted invention was undertaken. No patent dealing with or employing a similar method for gathering and analyzing user findings was found.

There are means that deal with and analyze emotions that use other tools and concepts differing from those presented in this invention.

### DETAILED DESCRIPTION OF THE INVENTION BODY

The Program and the Apparatus.

A program run using a device such as a cellular phone, laptop or desktop computer, personal digital assistant or a specific device developed for this application only.

The apparatus has a manual or voice operated user interface (see FIG. 4) containing a memory allowing for accumulation of user data, a mathematical processor for calculating the data matrix, a program converting the user data and performing the mathematical calculation of the happiness index, a data input system and a screen for data display, providing interactive audiovisual display of data with the user and providing for a quantitative calculation of data on the user's emotional state, providing recommendations to help achieve personal emotional objectives.

Data Input System For the Personal Attributes Level

A personal profile system provides for the input of a set of personal data according to the user's self-perception. The system receives the user profile relative to him based on a number of emotional and physiological fields.

The system receives data by marking or keying a term or stating the term out loud. The user provides quantitative information on the term that gives it a relative weight relative to all other terms.

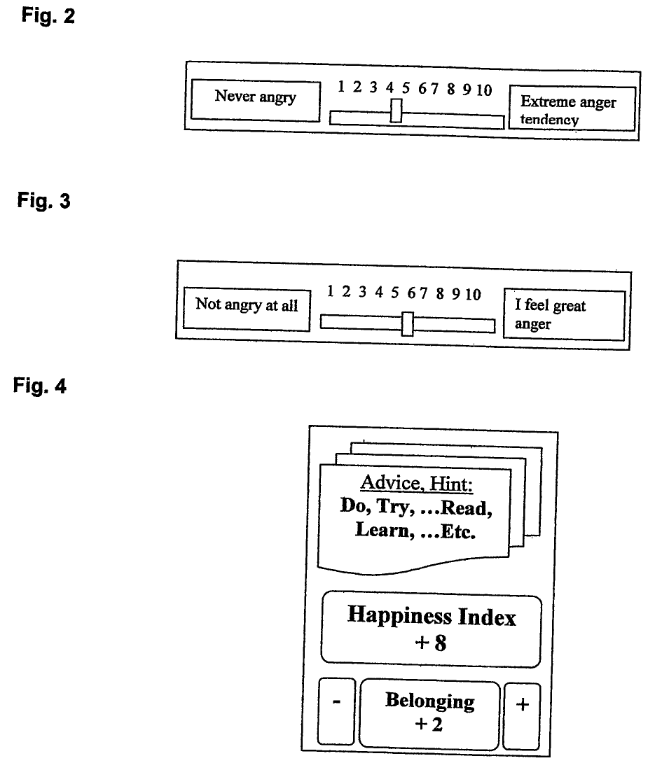

As depicted in FIG. 2, a scale allowing the user to define his tendencies regarding anger.

Emotional fields based on the user's self perception can be as follows:

Degree of tendency to envy others.

The user's tendency to identify his own fears.

The user's tendency to get angry.

The user's tendency to love.

The user's tendency to enact others—the need for control.

The user's tendency for desire and passion.

The user's tendency for company.

The user's tendency to feel loved.

The user's tendency to be alone or part of a group.

And other similar attributes that the user can set as major personality attributes.

The physiological/emotional fields manifest in the user's definition of his physiological needs, as per the following example:

Degree of need for physical/sporting activity

Frequency of food consumption

Frequency of sexual relations

And other similar attributes that the use can set as major personality and physiological structure attributes.

Apparatus For Inputting the User's Emotional State at a Given Time

This apparatus lets the user define, at a given point in time, his attitude to his physiological emotional attributes directly without relating to the personal attribute set or relating to the attribute set he defined in the personal attributes input system. The attitude is marked by selecting a number or marking on a scale or a verbal expression that is converted into a quantitative mark by the system. The scale, as in the previous section, may indicate as shown in FIG. 3, but a conceptually different appearance to that of the data input system may be designed. The user identifies his feelings for these attributes, for example:

The extent of sense of jealousy the user feels at the time of emotional reflection.

The extent to which the user feels love (inward or outward).

The degree of anger the user feels at this time.

The degree of loneliness that he feels—indicating this on a quantitative scale from very lonely to not lonely at all.

The degree of fulfillment of desire and passion, whether he craves for more passion in his life or is comfortable and maybe satiated—indicating this on a scale of very satiated or a great craving for passion.

Whether the user feels he has enough power owing to activities he has conducted during the last few hours, or feels a craving for more command and control—and indicating this accordingly on the scale.

Whether the user feels loved or not, stating this on the scale.

Whether the user feels neglected or wanted by people surrounding him, indicating this on the scale.

The user's degree of sexual satisfaction.

Whether he had physical exercise and the degree of satisfaction with it, and indicating this on the scale.

Whether he has properly eaten too much or little, and indicating this on the scale.

The degree of support and love he receives from his surroundings.

The degree of support and love he gives his surroundings.

Index of the general mood in his surroundings.

Index of the general mode in general as he feels it.

And various other attributes the user relates to and can update in his personal system.

A System Performing an Analysis for the Emotional State and Displaying an Index Known as the Happiness Index.

An algorithm that processes the personal data defined by the user and calculates the user's personal happiness index.

The algorithm processes each of the components according to the user's personal attributes or average attributes (if the user has not entered personal attributes) and adds or deducts points from the happiness index, the personal happiness index for a certain point in time is recorded in the processor, and the user can see the calculated change in his mood from time to time.

Calculation of the points for the happiness index is calculated according to the ratio between:

The definitions and the relations between them that the user set regarding his emotional nature and physiological needs, and:

His definition of his emotional feeling at that time.

For example: if he gave great weight (relative to other components) to his tendency to be angry and stated in the momentary reflection process that he felt very angry (on a defined scale), then the happiness index will decrease by a certain ratio corresponding with all the user's attributes. Should that momentary reflection of the user provide a high mark for the issue of control and the answer to the sense is strong and influential, then the happiness index will increase and rise back to the level corresponding with his condition.

(In other words, there are people who an identify themselves as angry but at the same time relatively happy, due to the alternative answer they identify in the need to control and influence, where as for others angriness will harm their happiness if it is not supported by another strong index at the same time).

In this process, the user's awareness of his situation will lead over time to an improvement in his happiness due to his ability to identify various components in his character, and reflect this happiness index to himself over time.

The Database Provides the User Feedback on His Image, Advice and Direction Based on His Personal Data.

The computer system is based on the user's personal data system and presents the user with alternatives to performing various actions, some of which are advice for actual enactment, and others material for thought in the form of directing questions.

According to the happiness index and personal data the user entered, recommendations will be chosen from the table using the mathematical algorithm for helping the user bring the happiness index to a higher level (should he opt to do so).

The user will also be able to state the name of the emotion he is interested in coping with directly (anger, for example), and receive guidelines and advice for helping him reduce his undesirable feelings. The various recommendations deal with various issues that can allow the user to achieve more, as known in various fields of psychology and therapy. The recommendations will help the user find solutions to issues such as loneliness, coping with anger, sadness, stress, anxiety, and many other feelings. The database is updated from time to time according to the development of the system and the user's choice to make the update in the various ways specified in the invention.

An example of possible advice:
After you finish what you are doing, find time to read the book ______chapter ______on the subject of______.
Call a friend and tell him or her how you feel.
Sit down and describe your feeling in writing, write down the reasons that led you to think this, reread them, and you shall see how things can change.

Such advice and guidelines will be prepared from time to time by psychology and therapy professionals and will be added to the database.

Creating Support Groups Through Communication Between Users.

In order to help and be helped by others, a group of people interested in communicating with each other, play and hear their experiences and feelings. The system provides the connectivity, and receives and displays messages using existing communication media (Internet, local area networks, landline and wireless communication, infrared, etc.) and communication networks developed in the future in the landline and wireless field.

In accordance with the device that the system is run on (computer, cellular phone, personal digital assistance, dedicated device), communication is performed to allow a number of users to receive information from others and send the information they produce using their system. This information is processed by the mathematical processor and allows the user to view data, whether at a group sharing level or individual to individual level, in accordance with his settings. The level of details transferred from one to another will be performed according to the users' wishes.

Group support will provide for information and idea sharing and direct support between users of the apparatus.

Support From a Human Operator

A user that identifies a personal need to transfer the results and happiness index components to a professional individual can do this using the apparatus. A voice connection will be made between the user and the professional party legally licensed to provide support for a user feeling such distress that the apparatus cannot help him.

A System Providing for Personal Database Update.

As stated in the previous section, the system will provide for the sending and receipt of updates from unique information centers developed for this purpose over the years. The centers will contain alternatives that will be more and more effective with the accumulation of the users' personal experience and an increase of awareness for using the apparatus.

Mathematical matrices will be used for forming mathematical correlations between knowledge items and setting types that the users make use of. The system will contain a personal user learning mechanism based on the user's use of the device.

The Innovation of the Patent

1. Awareness of emotional state provides for the achieving of personal goals in all fields and at all levels; because of the awareness you have of your emotional state, you can decide whether it is the right time for you to perform one task or another, and if you must perform a task, even if the time is not right, because you are aware of your situation, you can always maximize your performance—the means below are intended for improving your level of awareness of your emotions.
2. Your personal happiness level is composed of a range of components that affect the user's happiness as he defines it; the recording and selection of their importance as described in the invention help the user strive for more happiness.
3. A mechanism and method allowing the user to achieve higher awareness of his emotions and mood in an independent, subjective and personal manner and calculate his happiness index with the aim of leading to an improvement from one measurement to another with the help of structured proposal in the apparatus or with the help of other users who are connected to him, at his discretion and responsibility.
4. An apparatus allowing the user to identify in his awareness process his degree of responsibility for his feeling, thus personally coping with his feelings and avoid attributing them to an extrinsic source to the extent possible (which is something we often do).
5. A means for allowing the user to draw advice from the advice bank connected to the information system that the user puts into the apparatus, and through the connation the user can receive advice that is more aimed at the condition he describes himself in, thus attempting to improve his personal feeling independently.
6. Group support at a user level without a need for an actual meeting. Of course an unmediated meeting is usually more pleasant, but is usually unavailable, and through the group support group the group sessions can be more available and sometimes of better quality.

My claims are as follows:

1. An apparatus and method allowing a person to describe, through writing or selecting from a list into a database, attributes of emotional or physical significance that to his mind affect his happiness/mood in a manner that can define their personal importance and weight for him, and in the manner that he understands and expresses them.

2. An apparatus and method as claimed in claim 1 that allow a user to provide quantitative, comparative meaning for each of the attributes in an individual manner characterizing the user.

3. An apparatus and method as claimed in claim 2 allowing the user to enter his feeling at a certain time regarding his emotional and physiological attributes (some or all) into the apparatus in a manner that provides for their evaluation and quantification for the purpose of calculating the user's happiness index at the given time.

4. An apparatus and method as claimed in claim 3 for calculating a personal happiness index using an algorithm that processes the personal data defined by he user and calculates the user's personal happiness index. The algorithm processes each of the components according to the user's personal attributes or according to average attributes derived from evaluations and studies by professionals in the field (if the user has not entered personal attributes) and adds or deducts points from the happiness index. The happiness index calculation is performed according to the ratio between: the settings and the ratio between them that the user has defined regarding his emotional character and physiological needs, and: his definition of his emotional feeling at that time. As noted, if the user states a certain emotional field as being very meaningful and gives that emotion a bad assessment for the reflection at that time, this will cause a significant decrease in the happiness index, whereas a good assessment will cause a significant increase.

5. An apparatus and method as claimed in claim 4 whereby the user can calculate a quantitative index for his feelings and emotions in accordance with his personal data, an index that can be called, as noted, the happiness index or satisfaction index or any other characteristic and suitable name for the user's personal emotional state.

6. An apparatus and method as claimed in claim 5 whereby the said index receives the form of a number of alphabetical value, such as: excellent, good, medium, week, and using these terms, or allowing for the identification of a current state and comparing it to a previous state and the one before, and comparing it to the state of others if they act on the same set of variables.

7. An apparatus and method as claimed in claim 6 for calculating the user's personal happiness index, which is performed based on the evaluation of fulfillment of the user's personal needs.

8. An apparatus and method as claimed in claim 7 providing a user interface for updating the data entered following changes in his feeling and for recalculating the happiness index.

9. An apparatus and method as claimed in claim 8 providing for the receipt of assistance in the form of guidance, advice and assessments from the relationship between the personal database and the advice and guidance pool, and a connection between the database in the personal application or the database connected by wireless or landline telephone, By internet or local area network or non-personal multi-user network.

10. An apparatus and method as claimed in claim 9 providing for the transfer of user data to another user or a group of users for the purpose of receiving assistance and support or transferring of assistance or support to others.

11. An apparatus and method as claimed in claim 1 providing for interfacing with the application by sound (voice) and hearing.

12. An apparatus and method as claimed in claim 6 providing for the entering of data and receipt of feedback in a graphical or tabular format.

13. An apparatus or method as claimed in claim 10 that allow individuals in a group to calculate the group happiness index.

14. An apparatus and method as claimed in claim 13 allowing individuals in the group to give and receive support from the group members for improving the collective/common happiness index.

15. An apparatus and method as claimed in claim 14 providing for receipt of feedback from a person specializing in emotional support of others and receiving the user's details in real time while directly connected by a landline or wireless communication system and responding to and guiding the user.

16. An apparatus and method as claimed in claim 15 in which the system is to include a learning component for analyzing and associating information details that the user enters into the system and through the connection formed, the effectiveness of the advice and guidance will increase personally for the user.

17. An apparatus and method as claimed in claim 9 allowing the user to state a name of the emotion he wants to cope with and receive some advice and guidance immediatley to help him cope with his feeling.
